(19) United States
(12) Patent Application Publication
(10) Pub. No.: US 2009/0196255 A1
(43) Pub. Date: Aug. 6, 2009

(54) Differentiating GGSN terminated PDP context from PGW terminated EPS bearer during inter-RAT handovers

(75) Inventors: Giorgi Gulbani, Espoo (FI); Jan Kall, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/318,625

(22) Filed: Jan. 2, 2009

Related U.S. Application Data
(60) Provisional application No. 61/006,288, filed on Jan. 4, 2008.

(51) Int. Cl. H04W 84/02; H04W 36/00

(52) U.S. Cl. 370/331; 370/328

(57) ABSTRACT

A method and apparatus that can be used for differentiating a GGSN terminated PDP context from a PGW terminated EPS bearer during the Inter-RAT handovers are provided. The method can include checking an access point name received from a first network entity. The method can also include, when the access point name does not contain an evolved packet system specific label, initiating a context deactivation.

### REFERENCE TO RELATED APPLICATIONS

This application claims priority under 35 U.S.C. §119(e) of U.S. Provisional Patent Application Ser. No. 61/006,288, filed on Jan. 4, 2008. The subject matter of the earlier filed application is hereby incorporated by reference.

### BACKGROUND

1. Field

Certain embodiments of the present invention generally relate to telecommunications. For example, certain embodiments of the present invention relate to mobile wireless communications. In certain embodiments, the present invention addresses differentiating a Gateway General Packet Radio Service (GPRS) Support Node (GGSN) terminated Packet Data Protocol (PDP) context from a System Architecture Evolution (SAE) Packet Data Network (PDN) Gateway (PGW) terminated Evolved Packet System (EPS) bearer during Inter-Radio Access Technology (Inter-RAT) handovers.

2. Description of the Related Art

Operators that deploy the Evolved Packet System (EPS) may need to have roaming agreements with other operators that either support legacy-EPS interworking, or do not support legacy-EPS interworking. The following use cases, thus, are possible.

In a first case, a roaming partner may run a Third Generation Partnership Project (3GPP) Release 8 (R8) Universal Mobile Telecommunications System (UMTS)/Global System for Mobile communications (GSM) network. When a User Equipment (UE) attaches to such network, all PDP contexts will, in the first use case, terminate at a PGW.

In a second case, the roaming partner may run 3GPP pre-R8 UMTS/GSM network, which is capable of interworking with EPS. When a UE attaches to such a network, all the PDP contexts will, in this second case, terminate at the PGW.

In a third case, the roaming partner may run a 3GPP pre-R8 UMTS/GSM network, which is not capable of interworking with EPS. Thus, when a UE attaches to such a network, all PDP contexts will, in the third use case, terminate at a pre-R8 GGSN.

### SUMMARY

One embodiment of the present invention is a method. The method includes checking an access point name received from a first network entity. The method also includes, when the access point name does not contain an evolved packet system specific label, initiating a context deactivation.

Another embodiment of the present invention is an apparatus. The apparatus includes a checking unit configured to check an access point name received from a first network entity. The apparatus further includes a deactivation unit configured, when the access point name does not contain an evolved packet system specific label, to initiate a context deactivation.

A further embodiment of the present invention is an apparatus. The apparatus includes checking means for checking an access point name received from a first network entity. The apparatus also includes deactivation means for, when the access point name does not contain an evolved packet system specific label, initiating a context deactivation.

Yet another embodiment of the present invention is a computer program embodied on a computer-readable storage medium, encoding instructions configured to control processor to perform a process. The process includes checking an access point name received from a first network entity. The process also includes, when the access point name does not contain an evolved packet system specific label, initiating a context deactivation.

An additionally embodiment of the present invention is an evolved packet system label. The label includes an indicator configured to indicate a node capable of interworking with an evolved packet system. The indicator is disposed after a mobile network code and a mobile a country code in an evolved packet system access point name.

### BRIEF DESCRIPTION OF THE DRAWINGS

For proper understanding of certain embodiments of the invention, reference should be made to the accompanying drawings, wherein:

FIG. 1 illustrates a method according to an embodiment of the present invention.

FIG. 2 illustrates an apparatus according to an embodiment of the present invention.

FIG. 3 illustrates a system according to an embodiment of the present invention.

FIG. 4 illustrates an apparatus according to an embodiment of the present invention.

### DETAILED DESCRIPTION OF THE PREFERRED EMBODIMENT(S)

In certain embodiments, the present invention addresses differentiating a Gateway General Packet Radio Service (GPRS) Support Node (GGSN) terminated Packet Data Protocol (PDP) context from a System Architecture Evolution (SAE) Packet Data Network (PDN) Gateway (PGW) terminated Evolved Packet System (EPS) bearer during Inter-Radio Access Technology (Inter-RAT) handovers. Operators that deploy the Evolved Packet System (EPS) may need to have roaming agreements with other operators that either support legacy-EPS interworking, or do not support legacy-EPS interworking. The following use cases, thus, are possible.

In a first case, a roaming partner may run a Third Generation Partnership Project (3GPP) Release 8 (R8) Universal Mobile Telecommunications System (UMTS)/Global System for Mobile communications (GSM) network. When a User Equipment (UE) attaches to such network, all PDP contexts will, in the first use case, terminate at a PGW.

In a second case, the roaming partner may run 3GPP pre-R8 UMTS/GSM network, which is capable of interworking with EPS. When a UE attaches to such a network, all the PDP contexts will, in this second case, terminate at the PGW.

In a third case, the roaming partner may run a 3GPP pre-R8 UMTS/GSM network, which is not capable of interworking with EPS. Thus, when a UE attaches to such a network, all PDP contexts will, in the third use case, terminate at a pre-R8 GGSN.

A UE that is attached to a Serving GPRS Support Node (SGSN) may initiate PDP context activation. The selected Access Point Name (APN) (identified in the PDP context activation request) may resolve to a GGSN Internet Protocol (IP) address or to PGW IP address. As long as the PDP context at a GGSN cannot be moved, the handover to EPS will be impossible.

Several use cases can be considered. For example, in a first case, a pre-R8 UE simply cannot access (it conventionally lacks technological capability to access) Enhanced Universal Terrestrial Radio Access Network (E-UTRAN) and therefore the UE cannot roam from UMTS/GSN to EPS. Hence, it does not conventionally matter whether the PDP context terminates at GGSN, or not. In short, this is not a use case that needs to be concerned with how to handover from UMTS/GSN to EPS, because the device is not capable of the handover.

In a second use case, an R8 UE is handed over from an SGSN to a Mobility Management Entity (MME), and the MME may need to know whether the existing PDP context(s) terminate(s) at a GGSN or at a PGW. The reason for the potential need to know this information is that after the handover to EPS all contexts that terminate at GGSN must conventionally be dropped. The MME can be a physical device, such as a computer server, that is configured to manage and store a UE context. The MME can be configured to generate temporary identities and to allocate those temporary identities to UEs. Additionally, the MME can authenticate a user and check the authorization of a UE for various activities. The MME can be defined by its functionality, and consequently it is not necessary for the functions of the MME to performed by a stand-alone device, but rather the functions of the MME can also be included together with the functions of another network entity.

In a third use case, an R8 UE is handed over from R8 SGSN to pre-R8 SGSN, or vice versa, and the new SGSN may need to have an indication of whether the existing PDP context(s) terminate(s) at a GGSN or at a PGW. The reason for the need for such information is that after the handover to the new SGSN, yet another handover to an MME may take place, and the MME may need to know where the contexts terminate.

In a fourth use case, an R8 UE is handed over from MME to MME, in which case all existing EPS bearers terminate at a PGW. This situation should result in smooth transition.

In certain embodiments of the present invention a MME checks the APN received from an SGSN within a PDP Context Information Element (IE) and if the APN does not contain an EPS specific label (e.g. ‘eps’) then the MME initiates a context deactivation. Thus, certain embodiments can address the otherwise potentially troublesome transitions described in the immediately preceding second and third use cases.

The MME may need an indication to learn where the handed-over PDP context(s) terminate. Certain embodiments of the present invention address this problem.

MME conventionally will not automatically know whether the UE was served by an MME or by an SGSN. Therefore, MME can first send an S10 interface specific GPRS Tunneling Protocol (GTP) message to the peer. From the response message, the MME can learn whether the peer is an MME (S10 interface message), an R8 SGSN (S3 interface message), or a pre-R8 SGSN (Gn/Gp interface message).

The most challenging case is when the old SGSN happens to be pre-R8 SGSN, because the legacy SGSN cannot conventionally be enhanced with new features. Certain embodiments of the present invention offer the following way for solving the legacy problem.

For example, if a PDP context terminates at PGW then, during the context activation, one of the existing parameters (which is saved in the legacy SGSN) can indicate this.

The indication can be transparent to a legacy SGSN. By transparent, it is meant that the SGSN cannot comprehend the indication, but yet does not cause any errors in the SGSN. Additionally, the legacy SGSN can send this parameter within the existing legacy Routing Area Update (RAU) procedure to a new SGSN. This means that also the MME can receive it during the Inter-RAT handover. An APN IE can be included as a parameter for solving the problem. This can be accomplished by the EPS APN having an EPS specific label, e.g. ‘eps’.

Therefore, in one example, EPS APN should look like the following: “mnc<MNC>.mcc<MCC>.eps”

Thus, the MME can check the APN received from an SGSN within PDP Context IE. If the APN does not contain an EPS specific label (e.g. ‘eps’), this would mean that the context(s) are terminated at a GGSN. When the context(s) are terminated at a GGSN, the MME can initiate the deactivation of the PDP context(s). With such a solution, all the use cases discussed above, that need to be addressed, can be addressed.

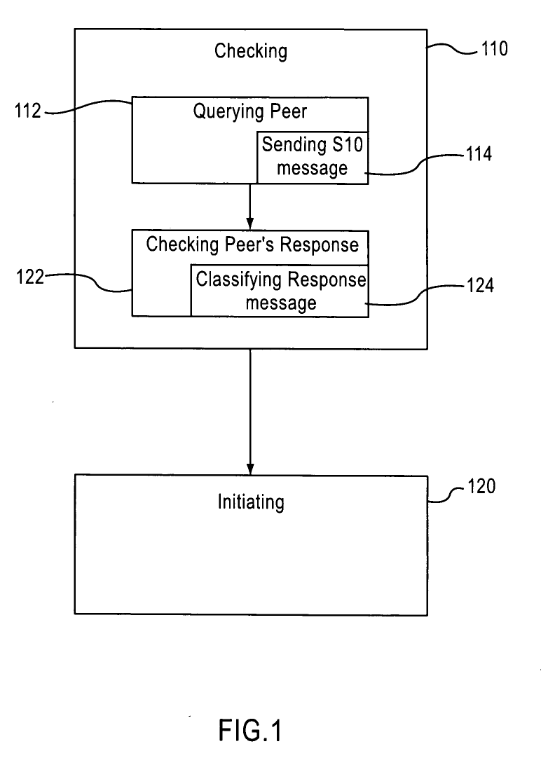

FIG. 1 illustrates a method according to an embodiment of the present invention. The method can be used for differentiating a GGSN terminated PDP context from a PGW terminated EPS bearer during the Inter-RAT handovers. This demonstrates that the method is useful, and has industrial application. The method, as illustrated in FIG. 1, can include checking 110 an access point name received from a first network entity. The method can also include, when the access point name does not contain an evolved packet system specific label, initiating 120 a context deactivation.

The method can be performed by a mobility management entity. The first network entity in the method can be a serving general packet radio service support node. The context to be deactivated can be a packet data protocol context. The access point name can be checked from a packet data protocol context information element. The checking 110 can include querying 112 a peer. The querying 112 can include sending 114 an S10 interface specific general packet radio service tunneling protocol message to the peer.

The checking 120 can include checking 122 a response message to a query. The checking 122 the response message can include classifying 124 the message as one of an S10 interface message, an S3 interface message, or an Gn/Gp interface message. The method illustrated in FIG. 1 can be performed during an inter-radio access technology handover and can be performed by a mobility management entity.

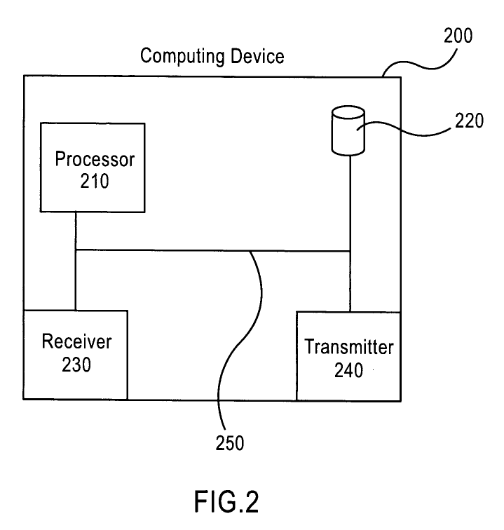

In certain embodiments of the invention, the method shown in FIG. 1 can be implemented in a computing device 200 shown in FIG. 2, such as a general purpose computer or application specific integrated circuit (ASIC). The computing device 200 can include a processor 210 that is configured to execute the method of FIG. 1 as instructed by a computer program. The computer program can be embodied on computer-readable medium 220 that encodes the instructions of the computer program. Examples of computer-readable media include hard disks, compact disks, flash Random Access Memory (RAM), and Electronically Programmable Read Only Memory (E-PROM). Such media may referred to as computer-readable storage media, in contrast to transient signals.

The computing-device 200 can also include a receiver 230, which may helpful in receiving responses to queries, and a transmitter 240, which may be helpful in sending queries. The processor 210, computer-readable medium 220, receiver 230, and transmitter 240 may be operably connected to one another. An operable connection is shown in FIG. 2 as bus 250, but there is no requirement for the particular connection illustrated in FIG. 2. Additional modules, such as a user interface, or peripheral devices may also be included.

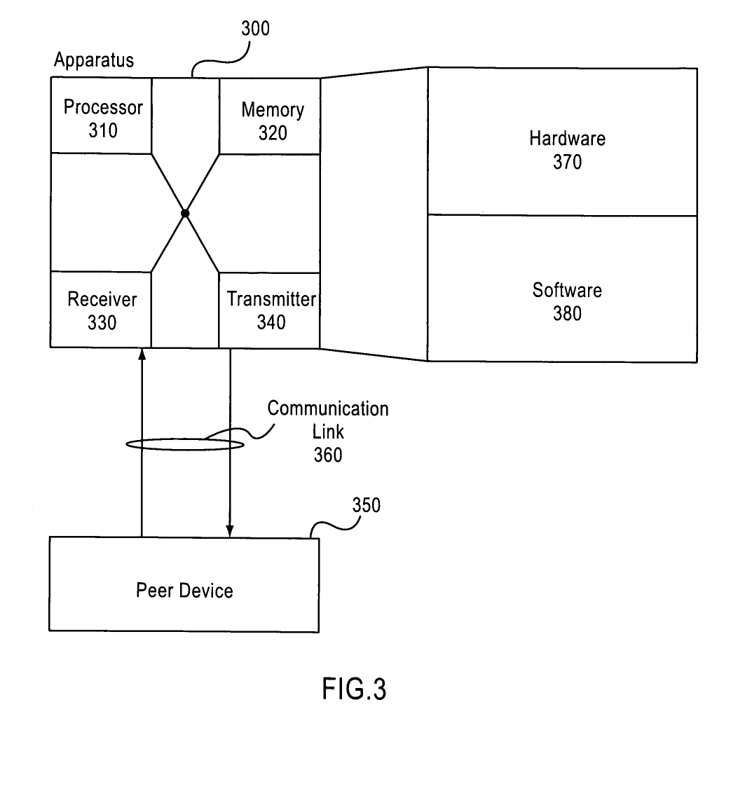

FIG. 3 illustrates an apparatus according to an embodiment of the present invention. As shown in FIG. 2, the apparatus 300 can include a processor 310, a receiver 330, a transmitter 340, and a memory 320. These various parts of the apparatus can include both software 380 and hardware 370. Thus, for example, the memory 320 can be a hardware device, such as RAM, and be encoded with software, such as a computer program.

The apparatus 300 can communicate with a peer device 350 over a communication link 360. This communication link 360 can be a direct link, as illustrated, or can be an indirect link through a network. It can be a wireless, wire lined, or hybrid wireless/wire lined link. Thus, the particular illustrated embodiment should not be considered to be limiting.

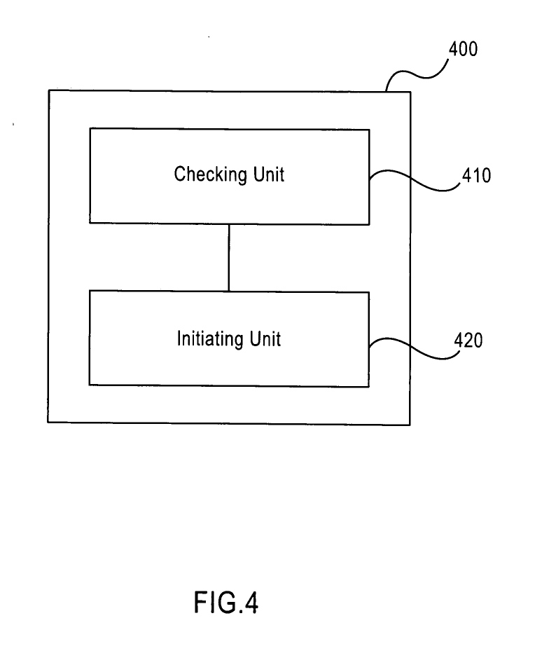

As illustrated in FIG. 4, viewed from a functional standpoint, an apparatus 400 can include a checking unit 410 configured to check an access point name received from a first network entity. The checking unit 410 can, for example, be a general purpose computer processor configured to perform the checking function using hardware and/or software programming.

The apparatus 400 can also include a initiating unit 420 configured, when the access point name does not contain an evolved packet system specific label, to initiate a context deactivation. The initiating unit 420 can, for example, be a general purpose computer processor configured to perform the initiating function. The same processor can be the checking unit 410 when it performs the functions of the checking unit 410 and the initiating unit 420 when it performs the functions of the initiating unit 420, although there is no definite requirement that the same processor be used

The apparatus 300, as illustrated in FIG. 3 can be, can be included in, or can include a mobility management entity. The first network entity or peer device 350 can be a serving general packet radio service support node.

In FIG. 4, the initiating unit 420 (which can also be referred to as a deactivation unit) can initiate deactivation of a context at an appropriate time. The context to be deactivated can be a packet data protocol context. The access point name can be checked from a packet data protocol context information element, and the checking can include querying a peer. The querying can include sending an S10 interface specific general packet radio service tunneling protocol message to a peer device. The peer can be a similar or functionally equivalent device to the apparatus 400, whether or not the peer has the functions required for certain embodiments of the present invention.

The checking unit 410 can check to see whether the initiating unit 420 should initiation context deactivation. The checking can include checking a response message to a query. The checking the response message can include classifying the message as one of an S10 interface message, an S3 interface message, or an Gn/Gp interface message. The apparatus 400 can be configured to check and deactivate during an inter-radio access technology handover.

The functional elements of a checking unit 410 and a initiating unit 420 can be implemented in hardware, software, or a combination thereof. For example, both the checking unit 410 and the deactivation unit 420 can be implemented in the processor 210, or by the interaction among processor 210, receiver 230, transmitter 240, and memory 220.

Certain embodiments of the present invention can transform a physical article, such as a computer memory, from a first state representing context activation, to a second state representing context deactivation, when a check of an access point name yields a negative result for evolved packet system.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the claims.

We claim:

1. A method, comprising:
checking an access point name received from a first network entity; and
when the access point name does not contain an evolved packet system specific label, initiating a context deactivation.

2. The method of claim 1, wherein the method is performed by a mobility management entity.

3. The method of claim 1, wherein the first network entity comprises a serving general packet radio service support node.

4. The method of claim 1, wherein the context to be deactivated comprises a packet data protocol context.

5. The method of claim 1, wherein the checking the access point name comprises checking a packet data protocol context information element.

6. The method of claim 1, wherein the checking comprises querying a peer.

7. The method of claim 6, wherein the querying comprises sending an S10 interface specific general packet radio service tunneling protocol message to the peer.

8. The method of claim 1, wherein the checking comprises checking a response message to a query.

9. The method of claim 8, wherein the checking the response message comprises classifying the response message as one of an S10 interface message, an S3 interface message, or an Gn/Gp interface message.

10. The method of claim 1, wherein the method is performed during an inter-radio access technology handover.

11. An apparatus, comprising:
a checking unit configured to check an access point name received from a first network entity; and
a deactivation unit configured, when the access point name does not contain an evolved packet system specific label, to initiate a context deactivation.

12. The apparatus of claim 11, wherein the apparatus comprises a mobility management entity.

13. The apparatus of claim 11, wherein the first network entity is a serving general packet radio service support node.

14. The apparatus of claim 11, wherein deactivation unit is configured to deactivate a packet data protocol context.

15. The apparatus of claim 11, wherein the checking unit is configured to check the access point name by checking a packet data protocol context information element.

16. The apparatus of claim 11, wherein the checking unit is configured to check the access point name by querying a peer.

17. The apparatus of claim 16, wherein the checking unit is configured to query the peer by sending an S10 interface specific general packet radio service tunneling protocol message to the peer.

18. The apparatus of claim 11, wherein the checking unit is configured to check the access point name by checking a response message to a query.

19. The apparatus of claim 18, wherein the checking unit is configured to classify the response message as one of an S10 interface message, an S3 interface message, or an Gn/Gp interface message.

20. The apparatus of claim 11, wherein the apparatus is configured to check and deactivate during an inter-radio access technology handover.

21. An apparatus, comprising:
checking means for checking an access point name received from a first network entity; and
deactivation means for, when the access point name does not contain an evolved packet system specific label, initiating a context deactivation.

22. A computer program embodied on a computer-readable storage medium, encoding instructions configured to control a processor to perform a process, the process comprising:
checking an access point name received from a first network entity; and
when the access point name does not contain an evolved packet system specific label, initiating a context deactivation.

23. An evolved packet system label, comprising:
an indicator configured to indicate a node capable of interworking with an evolved packet system,
wherein the indicator is disposed after a mobile network code and a mobile a country code in an evolved packet system access point name.
